(19) United States
(12) Patent Application Publication
(10) Pub. No.: US 2020/0175346 A1
(43) Pub. Date: Jun. 4, 2020

(54) System and Method for Pairing Asset Management Tag Device to an Information Handling System

(71) Applicant: DELL PRODUCTS, LP, Round Rock, TX (US)

(72) Inventors: Kevin W. Mundt, Austin, TX (US); Jon R. Hass, Austin, TX (US)

(21) Appl. No.: 16/208,882

(22) Filed: Dec. 4, 2018

(51) Int. Cl. G06K 19/07; G06K 7/10; H04W 4/029; H04W 4/02

(52) U.S. Cl. CPC G06K 19/0728; H04W 4/025; H04W 4/029; G06K 7/10366

(57) ABSTRACT

A method includes determining a first unique identifier corresponding to an information handling system. The method further includes providing the first unique identifier to an asset management tag device affixed to the information handling system, the asset management tag device is communicatively coupled to an asset management system.

### FIELD OF THE DISCLOSURE

This disclosure relates generally to information handling systems, and more particularly relates to pairing an asset management tag to an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems. When information handling systems are aggregated in great numbers at data centers, techniques for managing inventory and maintenance of individual systems is beneficial.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the present disclosure;

FIG. 2 is a block diagram illustrating a simplified view of a data center according to a specific embodiment of the present disclosure;

FIG. 3 is a flow diagram illustrating a method for pairing an information handling system with a corresponding asset management tag device according to a specific embodiment of the present disclosure;

FIG. 4 is a flow diagram illustrating a method for pairing an information handling system with a corresponding asset management tag device according to another embodiment of the present disclosure;

FIG. 5 shows a method for pairing an information handling system to a corresponding asset management tag device according to yet another embodiment of the present disclosure;

FIG. 6 shows a method for pairing an information handling system to a corresponding asset management tag device according to another embodiment of the present disclosure;

FIG. 7 shows a system including an asset management tag device paired to an information handling system according to a specific embodiment of the present disclosure;

FIG. 8 shows a system including an asset management tag device paired to an information handling system according to another embodiment of the present disclosure;

FIG. 9 shows a system including an asset management tag device paired to an information handling system according to yet another embodiment of the present disclosure; and

FIG. 10 shows a system including an asset management tag device paired to an information handling system according to still another embodiment of the present disclosure.

The use of the same reference symbols in different drawings indicates similar or identical items.

### SUMMARY

A method may include determining a first unique identifier corresponding to an information handling system. The method may further include providing the first unique identifier to an asset management tag device affixed to the information handling system, the asset management tag device communicatively coupled to an asset management system.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

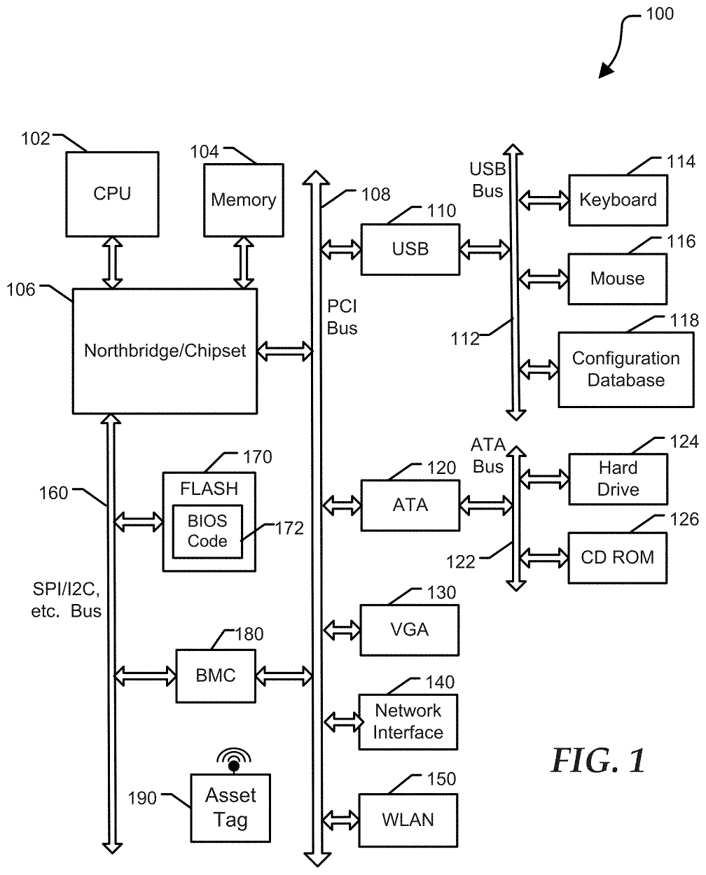

A data center is a facility used to house information handling systems and associated components. A data center can include hundreds, and commonly thousands of individual information handling systems, including servers, data storage devices, network devices, and the like. It is essential that a data center provide a reliable infrastructure for information technology (IT) operations in order to minimize service disruptions. Accordingly, a data center typically utilizes real-time monitoring of system operation. In addition, a data center may be subject to federal medical and banking regulations that require proper asset management of data center resources. Ultimately, an individual information handling system may need to be physically identified to perform maintenance. To facilitate locating a particular information handling system, each system can be equipped with an asset management tag device. Each tag device can be in wireless communication with one or more sensors arranged throughout the data center. An asset management system can identify the location of a particular asset management tag device, and accordingly, the associated information handling system. Each tag device is assigned a unique identifier, and the tag identifier is typically paired with a unique identifier corresponding to the associated information handling system. This pairing is usually performed manually by system administration personnel. FIGS. 1-10 illustrate techniques for automating the pairing of an individual tag device with a corresponding information handling system.

FIG. 1 illustrates an information handling system 100 including a processor 102, a memory 104, a northbridge/chipset 106, a PCI bus 108, a universal serial bus (USB) controller 110, a USB 112, a keyboard device controller 114, a mouse device controller 116, an ATA bus controller 120, an ATA bus 122, a hard drive device controller 124, a compact disk read only memory (CD ROM) device controller 126, a video graphics array (VGA) device controller 130, a network interface controller (NIC) 140, a wireless local area network (WLAN) controller 150, a serial peripheral interface (SPI) bus 160, a NVRAM 170, a baseboard management controller (BMC) 180, and an asset management tag device 190. NVRAM 170 can store a basic input/output system (BIOS) 172.

Information handling system 100 can include additional components and additional busses, not shown for clarity. For example, system 100 can include multiple processor cores, audio devices, and the like. While a particular arrangement of bus technologies and interconnections is illustrated for the purpose of example, one of skill will appreciate that the techniques disclosed herein are applicable to other system architectures. System 100 can include multiple CPUs and redundant bus controllers. One or more components can be integrated together. For example, portions of northbridge/chipset 106 can be integrated within CPU 102. Additional components of information handling system 100 can include one or more storage devices that can store machine-executable code, one or more communications ports for communicating with external devices, and various input and output (I/O) devices, such as a keyboard, a mouse, and a video display.

For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as CPU 102, a programmable logic array (PLA), an embedded device such as a System-on-a-Chip (SoC), or other control logic hardware. Information handling system 100 can also include one or more computer-readable medium for storing machine-executable code, such as software or data.

BMC 180 can be configured to provide out-of-band access to devices at information handling system 100. As used herein, out-of-band access refers to operations performed independent of an operating system executing at system 100, including operations performed prior to execution of BIOS 172 by processor 102 to initialize operation of system 100. BMC 180 can provide a network interface, a graphical user interface (GUI) and an application programming interfaces (API) to support remote management of system 100. In an embodiment, BMC 180 can include one or more proprietary or standardized bus interfaces, for example USB, I2C, and the like, to provide wired communication between BMC 180 and a bus interface connector provided at a bezel associated with system 100. As used herein, a bezel is a face-plate attached to a front surface of an information handling system, often including a locking mechanism to secure access to system 100 when installed in a chassis or rack system at a data center. In a particular embodiment, asset management tag device 190 is embedded or otherwise attached at a front surface of the bezel.

BIOS 172 can be referred to as a firmware image, and the term BIOS is herein used interchangeably with the term firmware image, or simply firmware. BIOS 172 includes instructions executable by CPU 102 to initialize and test the hardware components of system 100, and to load a boot loader or an operating system (OS) from a mass storage device. BIOS 172 additionally provides an abstraction layer for the hardware, i.e. a consistent way for application programs and operating systems to interact with the keyboard, display, and other input/output devices. When power is first applied to information handling system 100, the system begins a sequence of initialization procedures. During the initialization sequence, also referred to as a boot sequence, components of system 100 are configured and enabled for operation, and device drivers can be installed. Device drivers provide an interface through which other components of the system 100 can communicate with a corresponding device.

In an embodiment, the BIOS 172 can be substantially compliant with one or more revisions of the UEFI specification. The UEFI standard replaces the antiquated personal computer BIOS system found in some older information handling systems. However, the term BIOS is often still used to refer to the system firmware. The UEFI specification provides standard interfaces and interoperability guidelines for devices that together make up an information handling system. In particular, the UEFI specification provides a standardized architecture and data structures to manage initialization and configuration of devices, booting of platform resources, and passing of control to the operating system. The UEFI specification allows for the extension of platform firmware by loading UEFI driver and UEFI application images. For example, an original equipment manufacturer can include customized or proprietary images to provide enhanced control and management of the information handling system 100.

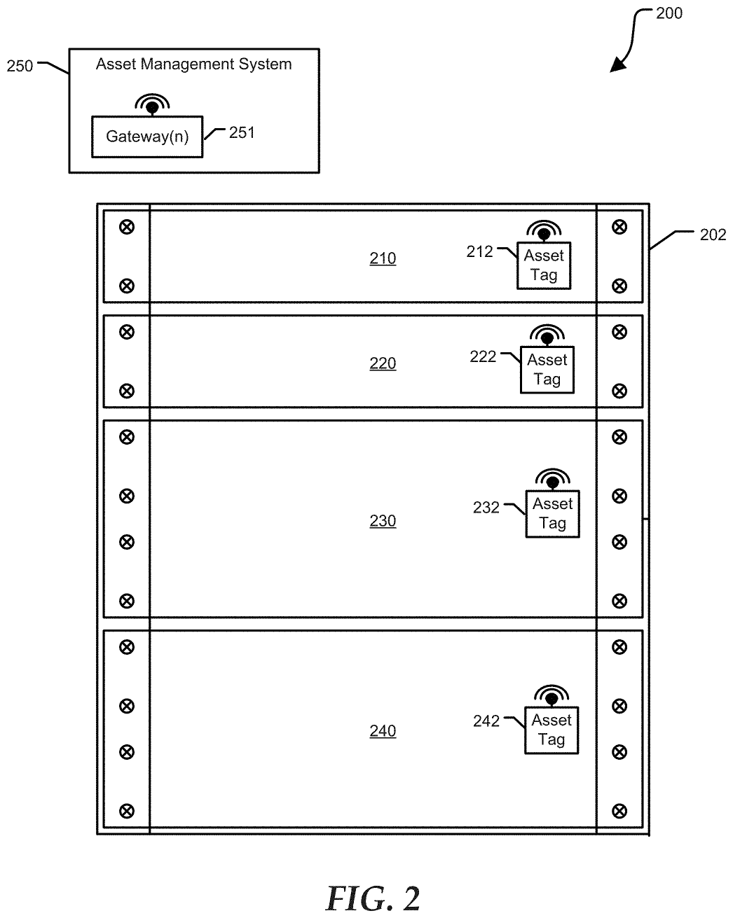

FIG. 2 shows a simplified view of a data center 200 according to a specific embodiment of the present disclosure. Data center 200 includes multiple equipment racks 202 for housing information handling systems 210, 220, 230, and 240. Information handling systems 210-240 can include servers, data storage systems, network or telecommunications equipment, and the like. Each of systems 210-240 is equipped with a corresponding asset management tag device, 212, 222, 232, and 242. Asset management tag devices 212-242 can be in wireless communication with one or more gateway devices 251 associated with an asset management system 250. In an embodiment, tag devices 212-242 can include an active radio device that can transmit and/or receive information with the gateways 251 of asset management system 250. Tag devices 212-242 can each further include a visible or infrared light-emitting diode (LED) and/or light sensors to provide optical communication with one or more gateway devices. Each tag device is assigned a unique identifier, which can be provided to asset management system 250 during operation. In a particular embodiment, an individual tag device can be in communication with multiple gateway devices, allowing asset management system 250 to use triangulation to identify a location of the tag device and the associated information handling system. In another embodiment, asset management system can transmit a signal causing an LED included at a particular tag device to be illuminated, thus allowing system administration personnel to locate the associated information handling system. Asset management system 250 and associated asset management tags and gateway devices can be provided by the original equipment manufacturer associated with systems 210-240, with the enterprise providing the data center services, or with a third-party service provider.

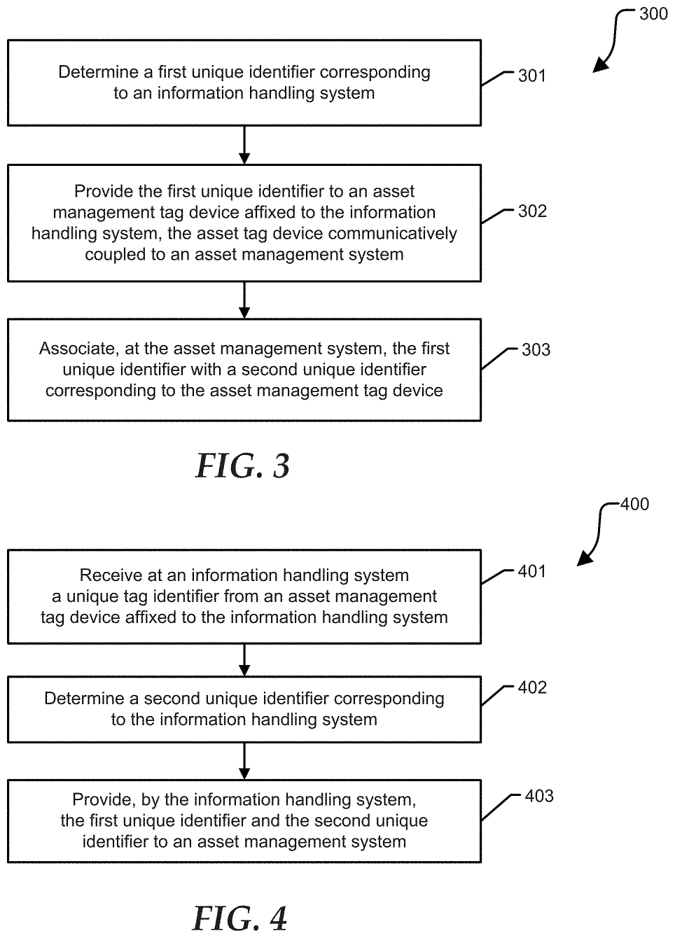

FIG. 3 shows a method 300 for pairing an information handling system to a corresponding asset management tag device according to a specific embodiment of the present disclosure. Method 300 illustrates how an information handling system can transmit a system identifier to an asset management tag device. Method 300 begins at block 301 where a first unique identifier corresponding to an information handling system is determined by the information handling system. The first unique identifier can include a serial number, product service code, media access control (MAC) address, or another identifier uniquely associated with the particular information handling system. The first unique identifier can be stored at a register or at another data storage device that is accessible to program code executable at the information handling system. Method 300 continues at block 302 where the first unique identifier is provided to an asset management tag device affixed to the information handling system, the asset tag device communicatively coupled to an asset management system. For example, information handling system 210 can transmit a serial number associated with system 210 to asset tag 212 via a direct electrical connection using a proprietary or standard bus protocol, an optical communications link, a wireless communication link, or the like. In an embodiment a BMC included at system 210 can determine the first unique identifier and provide the identifier to asset tag 212. The BMC can operate out-of-band and can transmit the first unique identifier to asset tag 212 when system 210 is not fully operational.

Method 300 completes at block 303 where the asset management system can associate the first unique identifier with a second unique identifier corresponding to the asset management tag device, referred to herein as pairing. For example, having received the first unique identifier from information handling system 210, asset tag device 212 can transmit the first unique identifier and the second unique identifier to asset management system 250, for example via one or more gateways 251. Asset management system 250 can further provide the pairing information and tag location information to other IT management systems. In an embodiment, asset management system 250 can provide or otherwise make available the pairing information and tag location information to a BMC included at information handling system 210. In an embodiment, system 210 can provide the first unique identifier to asset tag 212 on a recurring basis so that if an asset tag is moved from one information handling system to another system, updated pairing information can be provided to asset management system 250. While it may be preferable to maintain pairing information, in an embodiment only the first identifier can be sent to asset management system 250.

FIG. 4 shows a method 400 for pairing an information handling system to a corresponding asset management tag device according to another embodiment of the present disclosure. Method 400 illustrates how an asset management tag device can transmit a tag identifier to an information handling system. Method 400 begins at block 401 where a unique tag identifier from an asset management tag device embedded or otherwise affixed at the information handling system is received at an information handling system. For example, asset tag device 212 can transmit a unique identifier corresponding to asset tag 212 to information handling system 210 to via a direct electrical connection using a proprietary or standard bus protocol, an optical communications link, a wireless communication link, or the like. In an embodiment, a BMC at system 210 can include program code to identify the transmission from tag 212 and process the transmitted information accordingly.

Method 400 continues at block 402 where a second unique identifier corresponding to the information handling system is determined. As described above with reference to FIG. 3, information handling system 210 can include a data storage device for storing an identifier that is uniquely associated with system 210. Method 400 completes at block 403 where the information handling system can provide the first unique identifier and the second unique identifier to an asset management system. For example, information handling system can be coupled to asset management system 250 by a communications network and provide pairing information including the first unique identifier associated with the tag 212 and the second unique identifier associated with system 210 to asset management system 250.

Method 300 and method 400 can be supported by one or more software processes executing at an information handling system, for example systems 100 and 210-240, and by one or more software processes executing at a processor included at an asset tag device, for example tag devices 190 and 212-242. In an embodiment, the software processes executing at information handling system 100 can be associated with BMC 180 so that communication between system 100 and asset tag device 190 can be performed out-of-band relative to the primary operation of system 100. In another embodiment, the software processes executing at information handling system 100 can be performed by BIOS 172 during initialization of system 100. In still another embodiment, these processes can be executed by runtime services or applications that are executed under control of an operating system that has been loaded by BIOS 172. Pairing can be updated periodically and/or each time the information handling system is booted. An initial pairing of asset tag device 190 to information handling system 100 can be performed at an original equipment manufacture (OEM) facility or otherwise prior to installation at a data center so that asset management tracking of a new information handling system can commence as soon as the system arrives at a loading dock of the data center.

While method 300 and method 400 illustrate unidirectional communication between system 100 and asset tag device 190, one of skill will appreciate that such communication can be bidirectional. For example, information handling system 100 can transmit a unique identifier corresponding with system 100 to asset tag device 190, and tag device 190 can transmit a unique identifier corresponding to tag device 190 to information handling system 100.

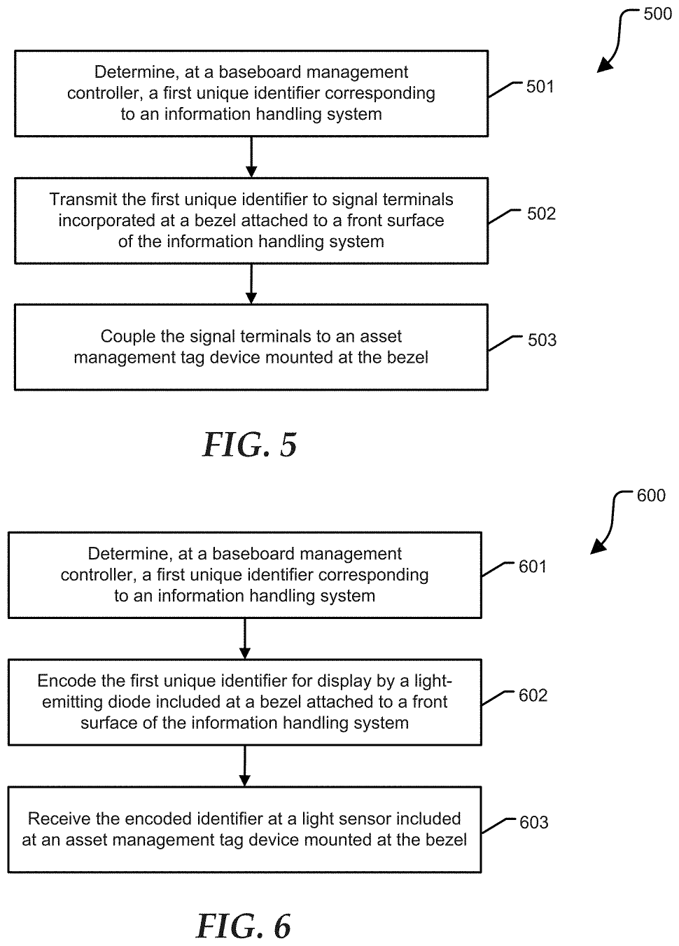

FIG. 5 shows a method 500 for pairing an information handling system to a corresponding asset management tag device according to yet another embodiment of the present disclosure. Method 500 illustrates how to couple an information handling system to an asset management tag device using a bezel. Method 500 begins at block 501 where a BMC included at an information handling system can determine a first unique identifier corresponding to the information handling system. The first unique identifier can include a serial number, product service code, or another identifier uniquely associated with the particular information handling system. Method 500 continues at block 502 where the first unique identifier is transmitted to signal terminals incorporated at a bezel attached to a front surface of the information handling system. Method 500 completes at block 503 where the signal terminals are coupled to an asset management tag device mounted at the bezel. For example, an information handling system can include a front bezel that includes one or more electrical connectors, for example pogo pins, to provide a data communication interface between information handling system 100 and the bezel. In an embodiment, the bezel can include a data connector to couple the data communication interface directly to asset tag device 190. A pogo pin usually takes the form of a slender cylinder containing a sharp, spring-loaded pin. Pressed between two electronic circuits, the sharp points at each end of the pogo pin make secure contacts with the two circuits and thereby connect them together. Alternatively, the electrical connectors can include spring-leaf terminals that mate with corresponding conductive terminals, for example as used in mobile phone devices to interface with a battery. Otherwise, tag 190 can include an additional cable to couple the interface to tag 190. In another embodiment, the bezel can include a non-volatile memory device that can store a unique identifier corresponding to information handling system 100 and/or a unique identifier corresponding to asset management tag 190.

FIG. 6 shows a method 600 for pairing an information handling system to a corresponding asset management tag device according to another embodiment of the present disclosure. Method 600 illustrates how to optically couple an information handling system to an asset management tag device. Method 600 begins at block 601 where a BMC included at an information handling system can determine a first unique identifier corresponding to the information handling system. Method 600 continues at block 602 where the first unique identifier is encoded for display by a light-emitting diode included at a bezel attached to a front surface of the information handling system. In an embodiment, the LED can be dedicated for the purpose of communicating with the tag 190. Alternatively, an existing LED at the bezel, for example a power indicator, status indicator, and the like, can be multi-purposed to transmit the first unique identifier. The optical encoding can include conventional or proprietary techniques, for example pulse width modulation, a serial interface protocol, and the like. Method 600 completes at block 603 where the encoded identifier is received at a light sensor included at an asset management tag device mounted at the bezel.

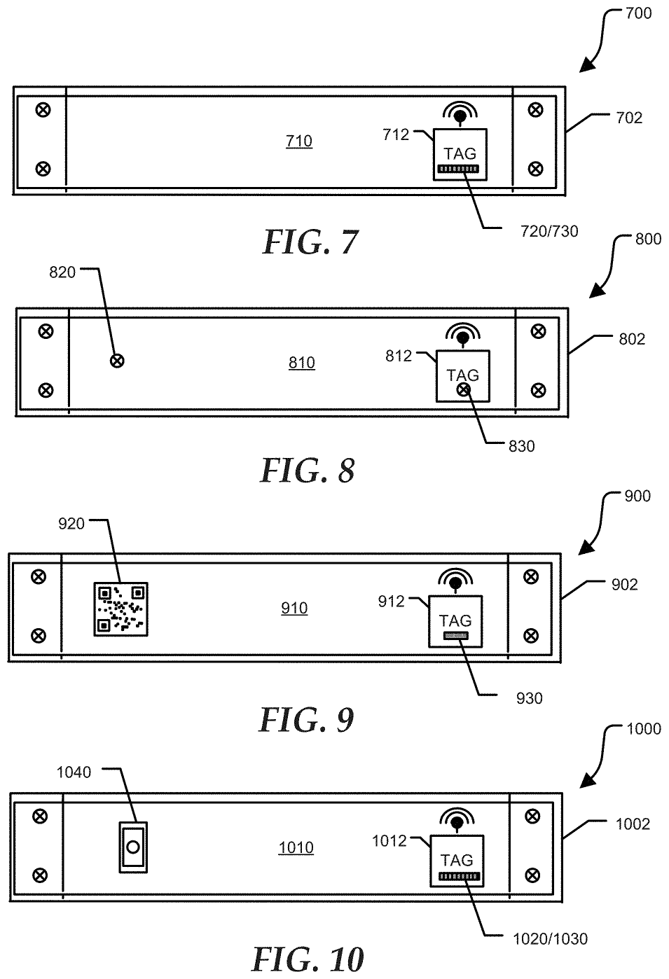

While method 500 and method 600 illustrate unidirectional communication between system 100 and asset tag device 190, one of skill will appreciate that such communication can be bidirectional. Additional techniques for providing intercommunication between system 100 and tag device 190 are described below with reference to FIGS. 7-10.

FIG. 7 shows a system 700 including an asset management tag device paired to an information handling system according to a specific embodiment of the present disclosure. System 700 includes an information handling system 710 incorporated at a rack 702, and an asset management tag device 712. Tag device 712 includes an electrical connector 730 that communicatively couples to a corresponding electrical connector 720 included at information handling system 710. During operation, asset management tag device 712 can communicate with an asset management system (not shown at FIG. 7) using an active radio device or another wireless technology. In an embodiment, electrical connector 720 can be incorporated at a bezel that is attached to a front surface of information handling system 710. Electrical connector 730 can be incorporated at a back surface of tag 712 and configured to mate with connector 720 when tag 712 is applied to the bezel. Pairing of system 710 and tag device 712 can be accomplished as described above. Data communication between system 710 and tag device 712 can be unidirectional or bidirectional.

FIG. 8 shows a system 800 including an asset management tag device paired to an information handling system according to another embodiment of the present disclosure. System 800 includes an information handling system 810 incorporated at a rack 802, and an asset management tag device 812. Information handling system 810 includes an LED 820, for example included at a bezel attached to system 810. LED 820 is communicatively coupled to system 810, for example to a BMC included at system 810. Tag device 812 includes a light-sensor 830 that is configured to receive optical data communication from LED 820. For example, a BMC at information handling system can encode a unique identifier corresponding to system 810 and optically transmit the encoded identifier to sensor 830. In another embodiment, tag 812 can include an LED to transmit a unique tag identifier to a sensor at system 810. In still another embodiment, system 810 and tag device 812 can each include an LED and an optical sensor, thereby providing bidirectional communication.

FIG. 9 shows a system 900 including an asset management tag device paired to an information handling system according to yet another embodiment of the present disclosure. System 900 includes an information handling system 910 incorporated at a rack 902, and an asset management tag device 912. Information handling system 910 includes a Quick Response (QR) Code emblem 920 onto which is printed an encoded unique identifier corresponding to information handling system 910. Asset tag device 912 includes an electrical connector 930, for example a USB port that supports interface to a mobile phone, a computer tablet, and the like. During a pairing process, a user can connect the phone to connector 930 and use the phone to scan the QR code 920. The unique identifier provided by the QR code can be provided to tag device 912 and/or directly to asset management system 250. As in all the illustrated scenarios, asset management tag device 912 can wirelessly communicate the pairing information including the unique identifier corresponding to information handling system 910 and a unique identifier correspond to asset tag device 912 to asset management system 250. In an embodiment, tag device 912 can directly interface to a BMC included at system 810 via a USB bus.

FIG. 10 shows a system 1000 including an asset management tag device paired to an information handling system according to still another embodiment of the present disclosure. System 1000 includes an information handling system 1010 incorporated at a rack 1002, and an asset management tag device 1012. Information handling system 1010 includes a switch 1040, for example a momentary contact push-button switch. Tag device 1012 includes an electrical connector 1030 that communicatively couples to a corresponding electrical connector 1020 included at information handling system 1010. Pairing is accomplished by pressing switch 1040. For example, pressing switch 1040 can signal information handling system 1010, for example a BMC included at system 1010, to transmit a unique identifier corresponding to system 1010 to asset tag device 1012 via connectors 1020 and 1030. Pairing in this manner can be in addition to periodic or automated pairing, as described above in the various embodiments.

Referring back to FIG. 1, the information handling system 100 can include a set of instructions that can be executed to cause the information handling system to perform any one or more of the methods or computer based functions disclosed herein. The information handling system 100 may operate as a standalone device or may be connected to other computer systems or peripheral devices, such as by a network.

In a networked deployment, the information handling system 100 may operate in the capacity of a server or as a client user computer in a server-client user network environment, or as a peer computer system in a peer-to-peer (or distributed) network environment. The information handling system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single information handling system 100 is illustrated, the term “system” shall also be taken to include any collection of systems or sub-systems that individually or jointly execute a set, or multiple sets, of instructions to perform one or more computer functions.

The information handling system 100 can include a disk drive unit and may include a computer-readable medium, not shown in FIG. 1, in which one or more sets of instructions, such as software, can be embedded. Further, the instructions may embody one or more of the methods or logic as described herein. In a particular embodiment, the instructions may reside completely, or at least partially, within system memory 104 or another memory included at system 100, and/or within the processor 102 during execution by the information handling system 100. The system memory 104 and the processor 102 also may include computer-readable media. A network interface device (not shown at FIG. 1) can provide connectivity to a network, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions or receives and executes instructions responsive to a propagated signal; so that a device connected to a network can communicate voice, video or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories.

Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
determining, at an information handling system, a first unique identifier corresponding to the information handling system; and
providing, by the information handling system, the unique identifier to an asset management tag device affixed to the information handling system, the asset tag device communicatively coupled to an asset management system.

2. The method of claim 1, further comprising:
associating, at the asset management system, the first unique identifier with a second unique identifier corresponding to the asset management tag device.

3. The method of claim 1, wherein the determining and the providing are performed by a baseboard management controller included at the information handling system.

4. The method of claim 1, wherein the determining and the providing are performed by a runtime process executed at a primary core processor at the information handling system.

5. The method of claim 1, wherein the determining and the providing are performed by pre-runtime firmware executed at a primary core processor at the information handling system.

6. The method of claim 1, further comprising providing the first unique identifier to the asset management tag device via an electrical interconnect coupling the information handling system to the asset tag device.

7. The method of claim 6, wherein the electrical interconnect is provided at a bezel incorporated at the information handling system.

8. The method of claim 1, further comprising providing the first unique identifier to the asset management tag device via an optical coupling between a light-emitting diode at the information handling system and an optical sensor at the asset tag device.

9. The method of claim 1, further comprising:
receiving at the information handling system a second unique identifier corresponding to the asset management tag device, the second unique identifier provided by the asset management tag device; and
providing, by the information handling system, the first unique identifier and the second unique identifier to the asset management system.

10. A method comprising:
receiving at an information handling system a first unique identifier corresponding to an asset management tag device affixed to the information handling system, the first unique identifier provided by the asset management tag device, the asset management tag device communicatively coupled to an asset management system;
determining, at the information handling system, a second unique identifier corresponding to the information handling system; and
providing, by the information handling system, the first unique identifier and the second unique identifier to the asset management system.

11. The method of claim 10, further comprising:
associating, at the asset management system, the first unique identifier with the second unique identifier.

12. The method of claim 10, further comprising receiving the first unique identifier at a baseboard management controller included at the information handling system.

13. The method of claim 10, wherein the receiving is performed by a runtime process executed at a primary core processor at the information handling system.

14. The method of claim 10, wherein the receiving is performed by pre-runtime firmware executed at a primary core processor at the information handling system.

15. The method of claim 10, further comprising receiving the first unique identifier at the information handling system via an electrical interconnect coupling the asset management tag device to the information handling system.

16. The method of claim 15, wherein the electrical interconnect is provided at a bezel incorporated at the information handling system.

17. The method of claim 10, further comprising receiving the first unique identifier at the information handling system via an optical coupling between a light-emitting diode at the asset tag device and an optical sensor at the information handling system.

18. The method of claim 10, further comprising:
providing, by the information handling system, the second unique identifier to the asset management tag device.

19. A system comprising:
an information handling system;
an asset management tag device physically attached to the information handling system, the information handling system to:
determine a first unique identifier corresponding to the information handling system; and
provide the unique identifier to the asset management tag device affixed to the information handling system, the asset tag device communicatively coupled to an asset management system.

20. The system of claim 19, the information handling system further comprising a baseboard management controller, and wherein the determining and the providing are performed by the baseboard management controller.
